(19) United States
(12) Patent Application Publication
(10) Pub. No.: US 2022/0396445 A1
(43) Pub. Date: Dec. 15, 2022

(54) Joint and a device for joining fiber web ends

(71) Applicant: Valmet Technologies Oy, Espoo (FI)

(72) Inventors: Arto LESKINEN, Jarvenpaa (FI); Mikko RÄMÄ, Jarvenpaa (FI)

(21) Appl. No.: 17/838,193

(22) Filed: Jun. 11, 2022

(30) Foreign Application Priority Data
Jun. 15, 2021 (FI) 20215702

(51) Int. Cl. B65H 19/18; B65H 21/00

(52) U.S. Cl. CPC B65H 19/1852; B65H 21/00; B65H 19/1857; B65H 2301/46

(57) ABSTRACT

A joint and device for joining ends of at least two fiber webs together, the joint being formed of at least one cut provided to penetrate through the ends of the fiber webs in an overlapping position, which cut has at least one side part and from the side part extending at least one substantially straight part and which cut, which forms at least one flap, being configured to remain attached to the fiber webs by at least one folding line substantially aligned with the direction of the movement of the fiber webs. The device comprises a tool with a cutting edge and a counter element with a groove and located on the opposite side of the fiber webs, and the tool protrudes into the groove. The groove has a greater cross-sectional area than the cross-sectional area of the tool such that a loose and spacey fitting is provided.

### TECHNICAL FIELD

The present invention relates generally to unwinding of fiber webs. In particular, the present invention relates to joining fiber web ends in a parent roll change of an unwinder, especially in an unwinder of a slitter-winder. More particularly the present invention relates to a joint according to the preamble of the independent joint claim and to a device according to the preamble of the independent device claim.

### BACKGROUND

As known, fiber webs, such as paper, board or pulp fiber webs, are manufactured in machines together forming a fiber web manufacturing line, which may be hundreds of meters long. Modern paper machines may produce more than 450,000 tons of paper per year. The speed of a paper machine may exceed 2000 m/min and the width of a paper fiber web may be more than 11 meters.

As known from the prior art in fiber web producing processes typically comprise an assembly formed by a number of apparatuses arranged consecutively in the process line. A typical production and treatment line comprises a head box, a wire section and a press section as well as a subsequent drying section and a reel-up. The production and treatment line can further comprise finishing devices, for example a calendar and/or a coater. The production and treatment line also comprise typically at least one slitter-winder for forming customer rolls as well as a roll packaging apparatus.

In fiber web production lines, manufacturing operates as a continuous process. The finished fiber web being output from the machine is wound with a reel-up around a reeling shaft, i.e. a reel spool, into a parent roll (a machine roll). The purpose of reeling is to modify the fiber web manufactured as planar into a more easily processable form. In the reel-up the continuous process of the machine breaks for the first time and shifts into periodic operation.

The fiber web wound onto the parent roll is full-width so it must be slit into partial fiber webs with suitable width and the partial fiber webs are wound to partial fiber web rolls (customer rolls) of suitable length or of suitable diameter for the customers. The slitting and winding take place as known from prior art in an appropriate separate machine i.e. in a slitter-winder.

As known from the prior art, in the slitter-winder the parent roll is unwound, the full-width fiber web is slit on the slitting section into several narrower partial fiber webs which are wound up on the winding section around winding cores or around winding shafts or around winding cores located on the shafts, such as spools, into customer rolls. When the customer rolls are completed, the slitter-winder is stopped and the rolls i.e. the so-called set is removed from the machine after which the process is continued with the winding of a new set. These stages are repeated periodically until fiber web runs out of the parent roll, whereby a parent roll change is performed, in which a trailing end of the running out parent roll is attached to the beginning end of the new parent roll and there after the operation continues again as the unwinding of a new parent roll, slitting the full-width fiber web into partial fiber webs and winding the customer rolls, or whereby a parent roll change is performed and the beginning end of the new parent roll is threaded to the winder.

As known from prior art, in connection with slitter-winders, a full-width fiber web coming from an unwinder is cut with the slitter-winder into partial fiber webs which are wound by a windup into partial fiber web rolls. A partial-fiber web windup can be a windup of carrier roll type in which the partial fiber web rolls are wound supported by carrier rolls by means of a winding nip between the forming fiber web roll and a second carrier roll. In the windup of carrier-roll type, the second carrier roll can be a set of belt rolls in which an endless belt loop is arranged around two rolls. The partial-fiber web windup can also be a center-driven windup in which the partial fiber web roll is rotated from the center and winding takes place by means of the nip between the forming fiber web roll and the winding drum.

When unwinding the fiber web from the unwinder and the roll being unwound is almost empty, the parent roll change is performed. This is often still done totally manually. In connection with the parent roll change the end of the emptying parent roll is to be attached to the end of the new, full parent roll by a joint for joining fiber web ends. Need to join fiber web ends occurs also in connection with other unwinders located in a fiber web production line.

In the joints and devices known from the prior art the joining of the fiber web ends is provided by using adhesive agent, for example glue or tape, which need equipment for providing the adhesive agent in order to create the joint between the fiber web ends. Naturally also a continuous supply of the adhesive agent is needed and furthermore there might exist a need for different types of adhesive agents depending on grades of fiber webs produced. It should also be noted that especially when producing thick fiber webs, such as pulp fiber webs the joints and devices known from prior art do not provide a satisfying solution as typically strength of the joint between the fiber web ends is not high enough.

It is known from prior art to join ends of fiber webs by a form-fitting overlapping joint. Typically in overlapping position placed ends of fiber webs are punched at several locations and flaps of cuts created by the punching form the form-fitting joint. Typically a punching assembly comprising punching blades, where one blade for each punch cut and a respective counter cut is provided, is used to press out two different types of paired flaps in the ends of the webs. Punched flaps are structured so that in one projecting tab and its flat section run with the direction of web travel and the other is similar but against the direction of web travel. Thus, the flap opens such that a folding line of the flap is straight in view of the web travel direction. When the flaps open the overlapping ends of the webs must move in respect of each other in accordance with the length of the flap before the joining occurs. In these kinds of arrangements it is disadvantageous that for each punch cut a respective counter cut is needed. This disadvantage even degrades, when the webs have a great width of several meters, as thus several individual punch cuts and counter cuts in width direction are needed to secure the joining. This increases cost of the devices used in the arrangements. Additionally disadvantageous is that these types of joints need movement of the overlapping web ends in respect of each other to secure the joining.

In patent application publication DE4124022A1 is disclosed an arrangement for thin material end joining, in which differing flaps punched through ends of the materials to hold the material ends together. The punching assembly comprising punching blades, where one blade for each punch cut and a respective counter cut is provided, is used to press out two different types of paired flaps in the ends of the webs. The punched flaps are structured so that in one projecting tab and its flat section run with the direction of material travel, and the other is similar but against the direction of material travel.

In patent application publication JPS624164A is disclosed a sheet connecting method, in which U-shaped cuts are bored at an overlap section of two sheets and one flap is protruded through the other cut. The sheets are displaced to join the flap with the cut. In this method one blade for each punch cut and a respective counter cut is provided.

A disadvantage in many of from the prior art known joints and devices is that even though they are as such well-functioning they might be too complicated and thus expensive for some of the present needs.

### SUMMARY

The object of the invention is to provide a joint in which the above-described disadvantages related to joining of ends of fiber webs have been eliminated or at least minimized.

An object of the invention is to create a joint and a device, in which disadvantages and problems of known joints and devices especially relating to joining of the fiber web ends in connection with a parent roll change in an unwinder are eliminated or at least minimized.

A particular object of the invention is to create a joint and a device relating to joining of the pulp web ends in the parent roll change in the unwinder of a slitter-winder.

In order to achieve the above objects and those described later the joint according to the invention is mainly characterized by the features of the characterizing part of the independent joint claim and the device according to the invention, in turn, is mainly characterized by the features of the characterizing part of the independent device claim. In the dependent claims further advantageous features and aspects of the invention are defined.

According to the invention the joint for joining ends of at least two fiber webs together is configured to be formed of at least one cut provided to penetrate through the ends of the fiber webs in an overlapping position, which cut has at least one side part and from the side part extending at least one substantially straight part and which cut, which forms at least one flap, which is configured remain attached to the fiber webs attached by at least one folding line, wherein the folding line of the flap is substantially aligned with the direction of the movement of the fiber webs.

The cut can be formed of a continuous cut line or it may comprise a partial tearing line/-s formed in connection with the cutting. Thus, the term “cut” in this description and the claims has the meaning of the continuous cut line and the cut line comprising the partial cut line/-s and the partial tearing line/-s.

The joint for joining the ends of at least two fiber webs may be located in each of the fiber webs can be located at any distance, same of different distance from the free edge of the end of the fiber web on the free runs of the ends of the fiber webs.

According to the invention the cut has a corner form in the direction of the movement of the fiber webs formed in meeting location of a side part of the cut and the folding line configured to form a carrying part of the joint.

According to an advantageous feature tension of the fiber webs is configured to tighten the joint due to the tensions of the fiber webs in respect of each other.

According to an advantageous feature the cut has two opposite arched or angular side parts and between the side parts extending substantially straight part and two flap parts are formed to the cut, which flap parts, are separated from each other by the between the side parts extending substantially straight part and remain attached to the fiber webs by the fold lines.

According to an advantageous feature several cuts are provided for the ends of the fiber webs to be joined.

According to an advantageous feature in the joint no adhesive or tape is used to join the ends of the fiber webs.

According to an advantageous feature the fiber webs are pulp webs.

According to the invention the device for joining ends of fiber webs together comprises a tool with a cutting edge configured to provide a cut to the ends of the fiber webs and a counter element with a groove or an opening or an elastic surface part, which tool is located on one side of the fiber webs and the counter element is located on the opposite side of the fiber webs in respect of the tool, in which the groove or the opening or the elastic surface part are positioned such that when the tool penetrates through the fiber webs, the tool penetrates into the groove or the opening or the elastic surface part of the counter element, wherein the groove or the opening of the counter element has a greater cross-sectional area than the cross-sectional area of the tool or the elastic surface part yields such that a loose and spacey fitting is provided.

According to an advantageous feature the device comprises a holder for holding and guiding the fiber webs.

According to an advantageous feature the holder is connected to the tool and movable with the tool or according to another advantageous feature the holder is independently movable.

According to an advantageous feature the counter element comprises a hold surface located opposite to the holder at the opposite side of the fiber webs in respect of the holder and the fiber webs are configured to be held between the hold surface and the holder.

According to an advantageous feature the tool has at least one cutting edge configured to provide a cut to the ends of the fiber webs and at least one opening edge for opening the cut in the fiber webs.

According to an advantageous feature the device is in an unwinder of a slitter-winder.

According to an advantageous feature the device is in an unwinder for pulp webs.

According to an advantageous aspect the joint and the device are configured to join an end of one fiber web to an end of another fiber web such, that the fiber webs are joined by a form-fitting joint and the one of the fiber webs can pull the other fiber web with desired tension and speed to desired location. The form-fitting joint provided is configured to withstand any possible turns etc. in perpendicular direction in respect of the surface level direction of the fiber webs, for example turns occurring when the fiber webs and the joint runs over guider rolls or like. Additionally, the form-fitting joint is configured to be created with minimum time.

According to an advantageous aspect joining of ends of fiber webs is provided by a device with the ends of the fiber webs in an overlapping position. The device comprises a tool, which in tensioned position is penetrated through the fiber webs against a counter element or while the fiber webs are moving in a same direction is protruded against a counter element. The counter element is provided with a groove or opening with greater area than the respective tool or the counter element is provided with an elastic part, which yields such that a loose and spacey fitting is provided. The tool is configured to penetrate through the overlapping ends of the fiber webs at the location of the respective groove or opening or elastic part of the counter element. Thus, the tool is also provided to protrude into the respective groove or opening or elastic part of the counter element. The cutting edge of the tool is configured to cut material of the ends of the fiber webs while protruding and additionally at final stage of the protruding open partially the cuts of the overlapping ends of the fiber webs. The shape of the groove or opening of the counter element can be different from the shape of the cutting form of the tool. Thus, the cutting edges of the tool cut the desired cutting form while penetrating through the tensioned fiber webs against the counter element or in case of thicker fiber webs, for example pulp webs, the cutting by the tool can be begun near edge of the groove or opening of the counter element to provide additional shear cutting effect. The cutting effect is substantially provided by the cutting edges of the tool and the cutting also utilizes properties of the fiber webs to be cut—the fiber webs being stiff and cuttable without the help of a form of the counter element strictly corresponding to that of the tool. Thus, in the manufacturing of the counter elements great advantages are achieved in view of tolerances and manufacturability, especially in cases of fiber webs with great widths, where several joints are needed in width direction to provide secure joining.

According to an advantageous aspect the tool of the device is configured to open the cut due to its protruding movement such, that a folding line/folding lines of the flap is substantially aligned with the direction of the movement of the fiber webs. Thus, the joint hold immediately in the direction of the movement of the fiber webs and no movement of the fiber webs in respect of each other is needed, as is the case in the arrangements according to the prior art. This provides for improved securing of the joint as no additional movements possibly damaging the movement is needed. Also, thus no special equipment is needed for the moving of the fiber webs in respect of each other for finalizing the joint.

According to an advantageous aspect after the joint is finished the fiber webs tighten in respect of each other due to form of the cut and the flap as individual joints tighten the one and the other fiber webs in respect of each other due to the flaps of the joint. The flaps positioned in the direction of the movement of the fiber web provide that stress of the joint is mainly in surface level of the fiber webs and thus the flaps are not susceptible to folding as much as in the arrangements according to prior art, where the flaps may open easily due to their perpendicular positioning in view of the direction of the movement of the fiber webs. This is especially important in connection with thinner paper or board grades, which are sensitive to folding.

According to the invention the cutting edges of the tool have a form that creates a corner form, advantageously a curve or a barb cut, in direction of the movement of the fiber web. This corner form is configured to bond the overlap during tightening of the fiber webs, which improves the secureness of the joint, especially when the fiber web runs in curved running path, as it prevents opening of the flaps curing the curved run.

The invention is suitable for different kinds of fiber webs, and it is especially advantageous in connection with thick fiber webs having a thickness about at least 0.14mm and it is very advantageous in unwinding of pulp fiber webs, because a very secure and well-functioning arrangement for pulp webs is now provided. In particular the known joints for joining the pulp web ends adhesive or tape joining providing high enough strength of the joint is not available, as the adhesive and tape joints of pulp web ends cause delamination of the pulp webs. Density of the pulp fiber web is about 400-800 kg/m3 and thickness of the pulp fiber web is about 0.5-2.5mm.

The invention is very advantageous when utilized in connection with an unwinder of a slitter-winder due to the sequential operation of the slitter-winders. The invention is also usable in connection with unwinders of other parts and sections of a fiber web production line.

By the joint and the device according to the invention many advantages are achieved: cost savings are achieved as the construction of the equipment needed is less complicated than in the arrangements known from prior art. No adhesive agent is used, and thus further cost savings are achieved and thus also the construction can be made simpler. The present invention also provides the possibility of joining web ends of different grades. Also, a simple and robust joining device construction is achieved.

The exemplifying embodiments of the invention presented in this patent application are not to be interpreted to pose limitations to the applicability of the appended claims. The verb “to comprise” and its derivatives are used in this patent application as an open limitation that does not exclude the existence of also unrecited features. The features described hereinafter are mutually freely combinable unless explicitly stated otherwise.

### BRIEF DESCRIPTION OF THE DRAWINGS

Aspects of the invention, however, both as to its construction and its method of operation, together with additional objects and advantages thereof, will be best understood from the following description of some example embodiments when read in connection with the accompanying drawings and in the following the invention is described in more detail referring to the accompanying drawing, in which

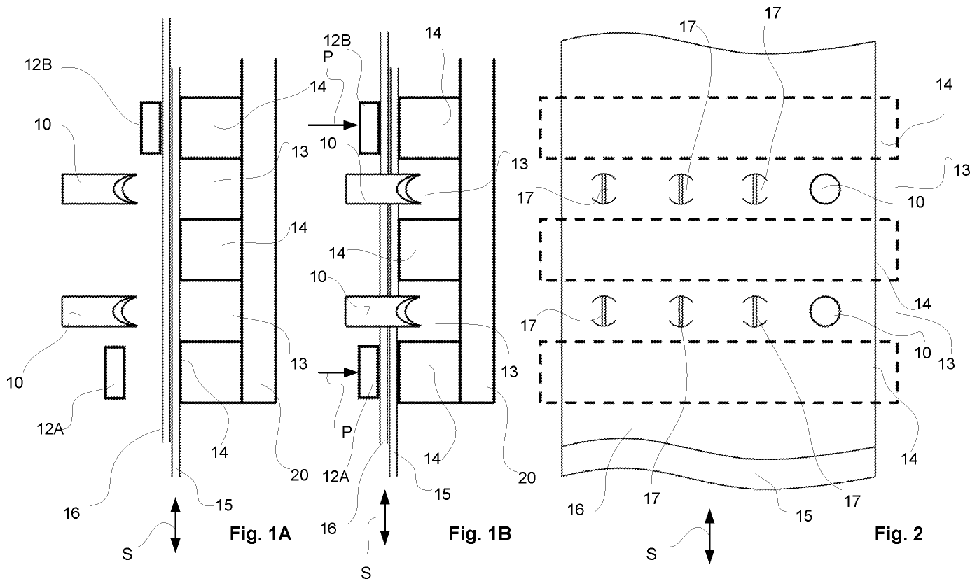

in FIG. 1A is schematically shown a side view of an advantageous example of a device providing joint for joining fiber web ends with the tool of the device in resting position,

in FIG. 1B is schematically shown a side view of an advantageous example of a device providing joint for joining fiber web ends with the tool of the device in protruding position,

in FIG. 2 is schematically shown as view in surface level of a fiber web an advantageous example of a device providing joint for joining fiber web ends with a counter element provided with grooves,

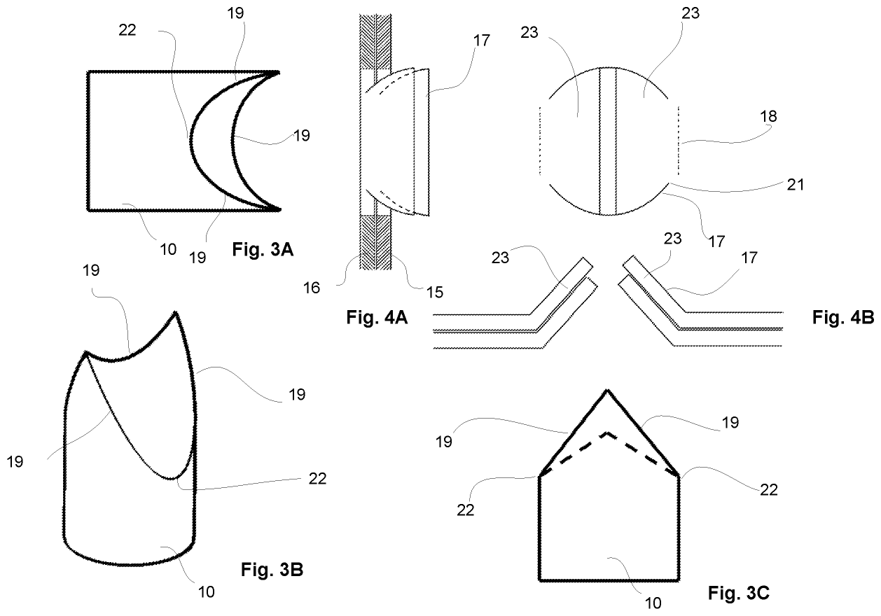

in FIGS. 3A-3C is schematically shown views of an advantageous example of a tool of the device providing joint for joining fiber webs,

in FIGS. 4A-4B is schematically shown views of an advantageous example of a joint for joining fiber webs during formation of the joint,

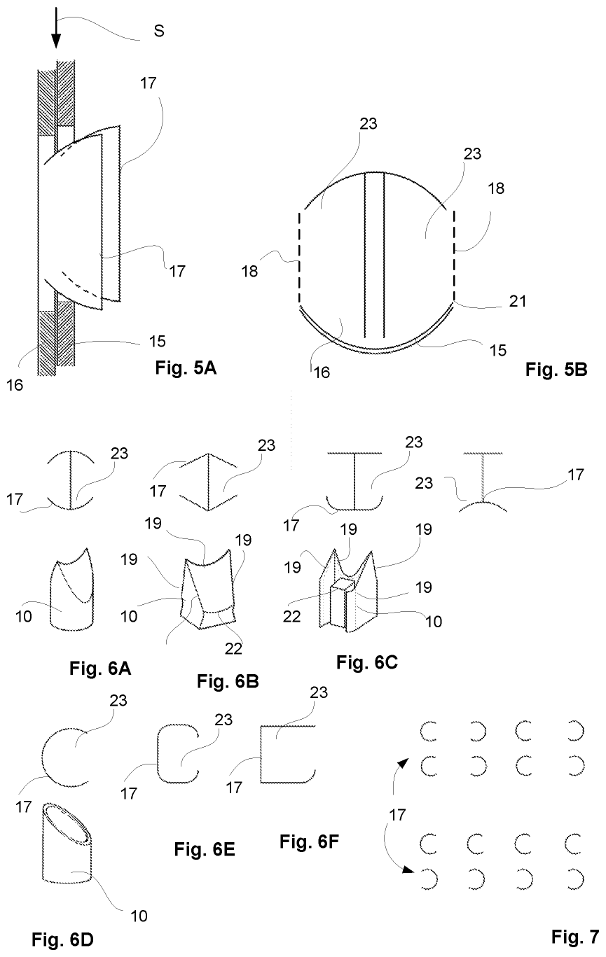

in FIGS. 5A-4B5B is schematically shown views of an advantageous example of a joint for joining fiber webs during overlap formation of the joint,

in FIGS. 6A-6F is schematically shown advantageous examples of a tool of a device and a joint form for joining fiber web ends,

in FIG. 7 is schematically shown advantageous examples of a cut for a joint for joining fiber web ends and

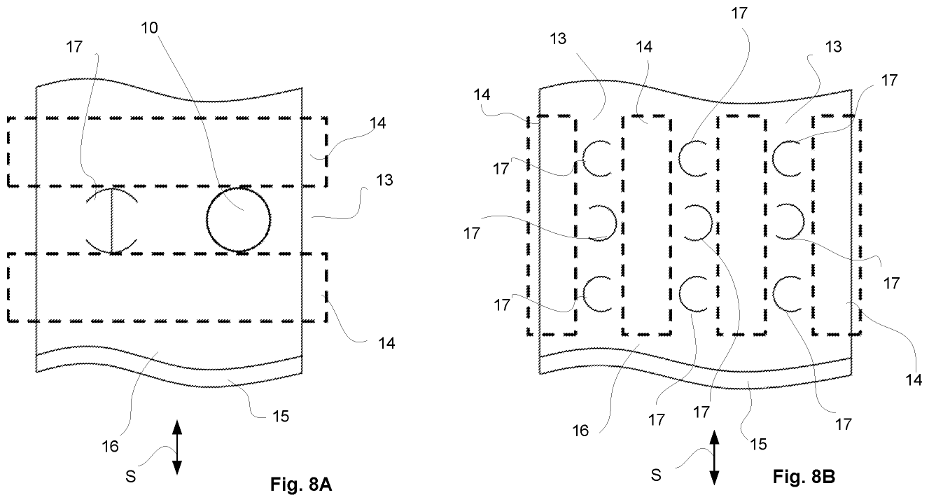

in FIGS. 8A-8B is schematically shown some examples of variations of the groove or opening of a counter element of a tool of a device for joining fiber web ends.

### DETAILED DESCRIPTION

During the course of the following description like numbers and signs will be used to identify like elements according to the different views which illustrate the invention and its advantageous examples. In the figures some repetitive reference signs have been omitted for clarity reasons.

In the example of FIGS. 1A-1B shown example of a device comprising a tool 10 and a counter element 20 providing joint for joining ends of fiber webs 15, 16. The direction S of the movement of the fiber webs 15, 16 is shown by the corresponding arrow. The device also comprises a holder 12A; 12B for holding and guiding the fiber webs 15, 16. In the FIGS. 1A-1B is shown two types of holder, in the figures the lower holder 12A is moving with the tool 10 and the upper holder 12B is not moving with the tool 10 but instead independently movable. During the joining of the ends of the fiber webs 15, 16 the upper holder 12B is in contact with the surfaces of the fiber webs and thus, holding and guiding the fiber webs 15, 16 all through the joining. The lower holder 12A moves with the tool 10 and thus holds and guides the fiber webs 15, 16 during punching of the fiber webs 15. 16. The counter element 20 of the device comprises a groove 13 or like opening at least for each tool 10. The counter element 20 may also comprise an elastic surface. The tool 10 is located on one side of the fiber webs 15, 16 and the counter element 20 is located on the opposite side of the fiber webs 15, 16 in respect of the tool 10. The grooves 13 are positioned such that when the tool 10 punches through the fiber webs 15, 16 the tool 10 protrudes into the groove 13 or the opening of the counter element 20 or the elastic surface of the counter element 20 yields as the tool 10 punched through the fiber webs 15, 16. The counter element 20 also comprises a hold surface 14 located opposite to the holder 12A, 12B at the opposite side of the fiber webs 15, 16 in respect of the holders 12A, 12B.

In FIG. 1A the tool 10 is in its resting position at a distance from the fiber webs 15, 16.

In FIG. 1B the tool 10 has penetrated and punched through the fiber webs 15, 16 to the corresponding groove 13 of the counter element 20 providing a cut to the fiber webs 15, 16. The holder 12A; 12B are holding the fiber webs 15, 16 against the corresponding hold surface 14 of the counter element 20.

In FIG. 2 is shown the fiber webs 15,16 and the device from above as can be noted the groove 13 is spacey in view of the tool 10 providing the cut 17 to the fiber webs 15, 16.

In FIGS. 3A-3C is shown an example of the tool 10 of the device providing joint for joining ends of the fiber webs 15, 16 and in FIGS. 4A-4B is shown an example of a joint for joining fiber webs during formation of the joint. The tool 10 has at least one cutting edge 19 creating the cut 17 to the fiber webs 15, 16 during penetrating and punching through the fiber webs 15, 16. The tool 10 also has at least one opening edge 22 for opening the cut 17 in the fiber webs 15, 16 while penetrating through the fiber webs 15, 16. The penetrating end of the tool 10 is in this example formed to have a substantially towards penetrating direction tapered form such, that at the first contacting part a substantially sharp edge line is formed, which may be towards the tool 10 curved, and that from ends of the first contacting, top sharp edge line away from the sharp edge line extending curved sharp side edge lines are formed and between the curved sharp side edge lines extending opening line 22 is provided. The tool 10 creates to the fiber webs 15, 16 the cut 17 with folding lines 18. The cut 17 has two opposite arched parts, corresponding to the sharp side edge lines of the tool 10 and between the arced parts extending substantially straight part, corresponding to the top sharp edge line of the tool 10. When the opening edge 22 penetrates the fiber webs 15,16 the cut 17 opens along the folding lines 18. The cut 17 also has a corner form 21, which forms the carrying part of the joint. In this example two flap parts 23 are formed to the cut 17, which flap parts 23, are separated from each other by the between the arced parts extending substantially straight part and remain attached to the fiber webs 15, 16 by the fold lines 18.

As can be seen from the FIGS. 5A-5B the cut 17 is created as an overlapping joint through the fiber webs 15,15 during penetrating a punching by the tensions of the fiber webs 15, 16 such that the actual cut 17 in each fiber web 15; 16 is slightly distanced, the flap parts 23 slightly overlapping. The distance is 0.1-10mm, advantageously 0.5-2mm, depending on the thicknesses of the fiber webs to be joined.

The joint and the device are configured to join an end of one fiber web 15 to an end of another fiber web 16 such, that the fiber webs 15, 16 are joined by a form-fitting joint and the one of the fiber webs 15;16 pulls the other fiber web 16; 15 with desired tension and speed to desired location overlapping position. The device comprises the tool 10, which tensioned position of the fiber webs 15, 16, is protruded against counter element 20. Alternatively, the tool 10, while the fiber webs 15, 16 are moving in a same direction, is protruded against the counter element 10. The counter element 20 is provided with a groove 13 or opening with greater area than the respective tool 10. The tool 10 is configured to penetrate through the overlapping ends of the fiber webs at the location of the respective groove 13 or opening of the counter element 20. Thus, the tool 10 is also provided to protrude into the respective groove 13 or opening of the counter element 20. The cutting edge 19 of the tool 10 is configured to cut material of the ends of the fiber webs 15, 16 while penetrating and additionally at final stage of the penetrating open partially the cuts of the overlapping ends of the fiber webs by the opening edge 22. The shape of the groove 13 or opening of the counter element 20 can be different from the shape of the cutting form of the tool 10. Thus, the cutting edge 19 of the tool 10 cuts the desired cutting form while penetrating through the tensioned fiber webs 15, 16 against the counter element 20. The tool 10 of the device is configured to open the cut 17 due to its protruding movement such, that the folding line 18 of the flap 23 is substantially aligned with the direction S of the movement of the fiber webs 15, 16. Thus, the joint holds immediately in the direction S of the movement of the fiber webs 15, 16. After the joint is finished the fiber webs 15, 16 tighten in respect of each other due to form of the cut 17 and the flap 23 as individual joints tighten the one and the other fiber webs 15, 16 in respect of each other due to the flaps 23 of the joint. The flap 23 is positioned in the direction S of the movement of the fiber webs 15, 16. The cutting edge 19 of the tool 10 has a form that creates the corner form 21, advantageously a curve or a barb cut, in direction S of the movement of the fiber web. This corner form 21 is configured to bond the overlap of the flaps 23 during tightening of the fiber webs 15, 16.

In FIGS. 6A-6C is shown some alternative examples of the tool 10 with respective cut 17 of symmetrical form and two flaps 23. The cutting edge 19 of the tool 10 is formed of at least the top edge part and the side edge parts with the opening part extending between the side edge parts. Thus, the cut 17 has the center cut formed by the top edge part and extending between the side cut parts formed by the side edge parts of the cutting edge 19. The folding lines 18 extends between the respective ends of the side cut parts and the flaps 23 are formed. In FIGS. 6D-6F is shown some examples of asymmetrical cuts 17 with one flap 23. Further in FIG. 7 is shown some examples of asymmetrical cuts with one flap 23 in the upper part of the figure positioned in different directions one after another and in the lower part of the figure positioned in different directions one below another.

In FIGS. 8A-8B is shown some examples of variations of the groove 13 or opening 13 of the counter element 20. In FIG. 8A is shown an example with less spacing, in which the beginning of the cutting is against sides of the opening 13. In FIG. 8B is shown an example with looser spacing and additionally showing groove 13 extending in the direction S of the movement of the fiber webs 15, 16.

In the description in the foregoing, although some functions have been described with reference to certain features, those functions may be performable by other features whether described or not. Although features have been described with reference to certain embodiments or examples, those features may also be present in other embodiments or examples whether described or not. Above the invention has been described by referring to some advantageous examples only to which the invention is not to be narrowly limited. Many modifications and alterations are possible within the invention as defined in the following claims.

Reference signs used in the drawing:

10 tool

12A, 12B holder

13 groove

14 hold surface

15 end of one fiber web

16 end of another fiber web

17 cut

18 folding line

19 cutting edge

20 counter element

21 corner form

22 opening edge

23 flap part

P holding pressure

S direction of movement of fiber web

1. Joint for joining ends of at least two fiber webs together, in which the joint is configured to be formed of at least one cut provided to penetrate through the ends of the fiber webs in an overlapping position, which cut has at least one side part and from the side part extending at least one substantially straight part and which cut forms at least one flap, which is configured to remain attached to the fiber webs attached by at least one folding line, which folding line of the flap is substantially aligned with the direction of the movement of the fiber webs, the cut having a corner form in the direction of the movement of the fiber webs formed in the meeting location of a side part of the cut and the folding line configured to form a carrying part of the joint.

2. Joint according to claim 1, wherein the tension of the fiber webs is configured to tighten the joint due to the tensions of the fiber webs in respect of each other.

3. Joint according to claim 1, wherein the cut has two opposite arched side parts and between the side parts extending substantially straight part and two flap parts are formed to the cut, which flap parts, are separated from each other by the between the side parts extending substantially straight part and remain attached to the fiber webs by the fold lines.

4. Joint according to claim 1, wherein several cuts are provided for the ends of the fiber webs to be joined.

5. Joint according to claim 1, wherein the joint has no adhesive or tape used to join the ends of the fiber webs.

6. Joint according to claim 1, wherein the fiber webs are pulp webs.

7. Device for joining ends of fiber webs together, which device comprises a tool with a cutting edge configured to provide a cut to the ends of the fiber webs and a counter element with one of a groove or an opening or an elastic surface part, which tool is located on one side of the fiber webs and the counter element is located on the opposite side of the fiber webs in respect of the tool, in which the one of the groove or the opening or the elastic surface part are positioned such that when the tool penetrates through the fiber webs, the tool protrudes into the one of the groove or the opening or the elastic surface part of the counter element, which one of the groove or the opening of the counter element has a greater cross-sectional area than the cross-sectional area of the tool or the elastic surface part of the counter element yields such that a loose and spacey fitting is provided, the cutting edge of the tool having a form that is configured to create a corner form of the cut in direction of the movement of the fiber webs configured to form a carrying part of a joint joining the ends of the fiber webs.

8. Device according to claim 7, wherein the device comprises a holder for holding and guiding the fiber webs.

9. Device according to claim 8, wherein the holder is connected to the tool and movable with the tool.

10. Device according to claim 8, wherein the holder is independently movable.

11. Device according to claim 8, wherein the counter element comprises a hold surface located opposite to the holder at the opposite side of the fiber webs in respect of the holder and that the fiber webs are configured to be held between the hold surface and the holder.

12. Device according to claim 7, wherein the tool has at least one opening edge for opening the cut in the fiber webs.

13. Device according to claim 7, wherein the device is located in an unwinder of a slitter-winder.

14. Device according to claim 7, wherein the device is located in an unwinder for pulp webs.
